(19) United States
(12) Patent Application Publication
(10) Pub. No.: US 2016/0257884 A1
(43) Pub. Date: Sep. 8, 2016

(54) LIQUID CRYSTAL POLYMER THIN FILMS AND METHODS OF MAKING AND USE THEREOF

(71) Applicant: BOARD OF REGENTS, THE UNIVERSITY OF TEXAS SYSTEM, Austin, TX (US)

(72) Inventors: Christopher J. Ellison, Austin, TX (US); Zhenpeng Li, Austin, TX (US)

(21) Appl. No.: 15/059,381

(22) Filed: Mar. 3, 2016

Related U.S. Application Data
(60) Provisional application No. 62/127,564, filed on Mar. 3, 2015.

(51) Int. Cl. C09K 19/38

(52) U.S. Cl. CPC C09K 19/3809

(57) ABSTRACT

Described are compositions that comprise one or more layers of a liquid crystal polymer (LCP). Each of the one or more layers can have an average thickness, for example, of 1000 nanometers (nm) or less. The layer(s) can, in some examples, have an oxygen permeability of 1×10⁻³ barrer or less. In some examples, the layer(s) can be substantially impermeable to gas diffusion. Also disclosed herein are methods of using compositions disclosed herein, for example as gas barriers and in food packaging materials.

### CROSS-REFERENCE TO RELATED APPLICATIONS

This application claims the benefit of priority to U.S. Provisional Application No. 62/127,564, filed Mar. 3, 2015, which is hereby incorporated herein by reference in its entirety.

### STATEMENT REGARDING FEDERALLY SPONSORED RESEARCH

This invention was made with government support under Grant No. DMR0423914 awarded by the National Science Foundation. The government has certain rights in this invention.

### BACKGROUND

Previous studies have shown that the structure and thermophysical properties of polymers can be affected by nanoconfinement. However, most of the studies performed in this area are focused on the effect of nanoconfinement on conventional amorphous or semi-crystalline polymers. A comprehensive understanding of structure and ordering of nanoconfined liquid crystal polymers (LCPs) is still lacking. The materials and methods discussed herein address these and other needs.

### SUMMARY

In accordance with the purposes of the disclosed compositions and methods, as embodied and broadly described herein, the disclosed subject matter relates to compositions and methods of making and using the compositions. More specifically, according to the aspects illustrated herein, there are provided liquid crystal polymer (LCP) thin films and methods of making and use thereof.

Disclosed herein are compositions that comprise one or more layers of a liquid crystal polymer (LCP). The LCP can comprise any LCP of interest, including main chain liquid crystal polymers, side chain liquid crystal polymers, and combinations thereof. In some examples, the LCP can comprise a random copolyester comprising hydroxybenzoic acid and 2,6-hydroxynaphthoic acid, for example VECTRA™.

Each of the one or more layers can have an average thickness, for example, of 1000 nanometers (nm) or less (e.g., 500 nm or less, 100 nm or less, etc.). In some examples, the average thickness of each of a layer can range from 5 nm to 1000 nm.

The disclosed compositions can, in some examples, exhibit optical anisotropy. For example, the ordinary refractive index (nₒ) (e.g., the in-plane refractive index) can be greater than the extraordinary refractive index (nₑ) (e.g., the out-of-plane refractive index) at one or more wavelengths. In some examples, the ordinary refractive index (nₒ) can be greater than the extraordinary refractive index (nₑ) by 10% or more at one or more wavelengths. The ordinary refractive index (nₒ) of the layer can, for example, be from 1.7 to 1.9 at one or more wavelengths of interest (e.g., one or more wavelengths from 400 nm to 1000 nm). The extraordinary refractive index (nₑ) of the layer can, for example, be from 1.5 to 1.7 at one or more wavelengths of interest (e.g., one or more wavelengths from 400 nm to 1000 nm).

In some examples, the layer can be substantially optically transparent. For example, the average transmittance of the layer over wavelengths from 400 nm to 750 nm can be 80% or more.

In some embodiments, the mesogens of the LCP can be aligned within the plane of each of the one or more layers. In some examples, the one or more layers can have an orientational order of from 0.15 to 0.55.

The one or more layers can, in some examples, have a low oxygen permeability. For example, the one or more layers can have an oxygen permeability of 1×10⁻³ barrer or less. In some examples, the one or more layers can be substantially impermeable to gas diffusion.

In some examples, the one or more layers can be supported by a substrate. In some examples, the T_{g} of the one or more layers supported by a substrate can increase as the thickness of the LCP thin film decreases. In some examples, the T_{g} of the one or more layers supported by the substrate can be greater than the T_{g} for the bulk LCP (e.g., a layer of LCP with a thickness greater than 1 μm).

In some examples, the T_{g} of the one or more layers supported by a substrate can decrease as the thickness of the LCP thin film decreases. In some examples, the T_{g} of the one or more layers supported by a substrate can be less than the T_{g} for the bulk LCP (e.g., a layer of LCP with a thickness greater than 1 μm).

Also disclosed herein are methods of making the compositions disclosed herein. The methods can comprise forming the LCP layers, for example by spin coating, melt processing, coextruding, or a combination thereof, the one or more layers of the LCP onto a substrate.

Also disclosed herein are methods of using the disclosed compositions. The compositions described herein can be used in a variety of applications, including, but not limited to, high performance gas barriers, gas separation membranes (e.g., for gas/water separation), solar cells, fuel cells, electronic devices, optical devices, coatings, standalone films, laminates, as active layers in multilayer films, food packaging, and the like, or combinations thereof. Also disclosed herein are gas barriers comprising any of the compositions described herein. Also disclosed herein are food packaging materials comprising any of the compositions described herein.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 displays the structures of (a) HBA-HNA-MCLCP and (b) poly(ethylene-co-norbornene).

FIG. 2 displays the measured thickness of a MCLCP thin film by ellipsometry (solid line) and fitted by Equation (2) (dashed line) as a function of temperature on a silicon wafer. The measurement was taken at a cooling rate of 2° C./min.

FIG. 3 displays a schematic representation of the grafting of MCLCP polymer chains onto the silicon wafer surface.

FIG. 4 displays the measured thickness of PEN thin film by ellipsometry (solid line) and fitted by Equation (2) (dashed line) as a function of temperature on a silicon wafer. The measurement is taken at a cooling rate of 2° C./min. The PEN thin film was annealed at 200° C. under vacuum for 12 hours prior to the measurement.

FIG. 5 displays the measured thickness of MCLCP thin film on a PEN layer by ellipsometry (solid line) and fitted by Equation (2) (dashed line) as a function of temperature. Measurement was taken at a cooling rate of 2° C./min.

FIG. 6 displays the T_{g} of a MCLCP thin film on a silicon wafer with native oxide (▪) and PEN () substrates as a function of MCLCP film thickness.

FIG. 7 displays the measured and isotropic or uniaxial model fit to Psi and Delta ellipsometry data of a 100 nm thick MCLCP thin film supported on PEN.

FIG. 8 displays the dispersion of refractive index nₒ and nₑ for a 100 nm thick MCLCP thin film supported on PEN.

FIG. 9 displays the AFM phase image of a 100 nm thick MCLCP thin film supported on PEN.

FIG. 10 displays the dispersion of the refractive indices nₒ and nₑ for a 100 nm thick PEN thin film.

FIG. 11 displays (a) a schematic diagram of the polarized ATR-FTIR measurement of a sample film and (b) representative polarized ATR-FTIR spectra for a PEN layer supported by a PP sheet.

FIG. 12 displays (a) representative polarized ATR-FTIR spectra for a 70 nm MCLCP thin film on a PEN layer supported by a PP sheet and (b) a schematic representation of the C═C and C═O ‘in plane’ stretches.

FIG. 13 displays the in-plane orientational order of MCLCP chains in thin films as a function of film thickness.

FIG. 14 displays a schematic representation of a multiple cycle spin coated thin film.

FIG. 15 displays a schematic representation of a multiple cycle spin coated LCP thin film with a PDMS top coat.

FIG. 16 displays a schematic representation of a free standing thin film lifted onto a copper wire frame with the LCP layer touching the copper wire.

FIG. 17 displays a schematic of a mounted sample for permeation testing.

FIG. 18 displays a schematic of the constant-volume, variable-pressure permeation cell used to measure pure gas permeability coefficients.

FIG. 19 displays the O₂ permeability of LCP thin films with various film thickness.

FIG. 20 displays (a) a schematic diagram of the polarized ATR-FTIR set up, (b) the polarized ATR-FTIR spectra of a PDMS −200 nm HBA-HNA-MCLCP bilayer film, and (c) a schematic representation of the C═C and C═O ‘in plane’ stretches.

FIG. 21 displays (a) the orientation order of LCP chains as a function of film thickness and (b) a schematic representation of the tortuous gas molecule diffusion pathway through the in-plane oriented LCP chains.

FIG. 22 displays the UV-Vis transmittance spectra of free-standing single layer HBA-HNA-MCLCP thin films with different thicknesses.

### DETAILED DESCRIPTION

The methods and compositions described herein may be understood more readily by reference to the following detailed description of specific aspects of the disclosed subject matter and the Examples included therein.

Before the present methods and compositions are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

As used herein, “molecular weight” refers to weight-average molecular weight, unless clearly indicated otherwise.

Disclosed herein are compositions that comprising one or more layers of a liquid crystal polymer. Liquid crystalline polymers (LCPs) are polymers that can exhibit liquid crystal phases. A LCP can exhibit a liquid crystal phase at a certain temperature or over a range of temperatures; at other temperatures the LCP can, in some examples, exist as an amorphous liquid, an amorphous glass or semicyrstalline polymer, or a combination thereof. In the liquid crystal phase, molecules have a degree of order which lies between a non-ordered amorphous liquid and a three-dimensional ordered crystal.

LCPs are composed of rigid liquid crystal units called mesogens, which can be, for example, rod-like or disk-like in shape. According to the way these mesogens are incorporated into the polymer, LCPs can be classified as main chain liquid crystalline polymers (MCLCPs), in which mesogens are connected in the polymer backbone, or side chain liquid crystalline polymers (SCLCPs), in which mesogens are attached to the backbone as side pendants. LCPs can exhibit mesophases between the solid and liquid phase, in which they can flow like a fluid but still possess a long range positional and orientational order. In the liquid crystal state, LCP chains can be aligned in a specific direction by external forces (e.g. shear flow, magnetic fields, etc.), which can affect the properties of the LCPs (e.g., mechanical, optical, and/or transport properties).

Main chain liquid crystalline polymers (MCLCPs) have received interest because of their optical and dielectric properties, chemical resistance and gas/liquid barrier properties. In the last few decades, MCLCPs have been developed into ultrahigh modulus fibers. One of the most famous examples is Kevlar poly(p-phenylene terephthalamide), whose tensile modulus is in the range of 9-17 Mpsi, while traditional commercial polymer fibers like nylon and polyethylene terephthalate (PET) are only about 0.9 and 1.8 Mpsi, respectively (Chung T S. Polymer engineering and science. 1986, 26(13), 901-919). These mechanical and optical properties of the MCLCP materials can be due to their ability of forming regions of highly ordered structure while maintaining the ability to flow like liquids.

Even though studies have been performed regarding the structure and properties of MCLCPs, most of these studies have investigated bulk materials. Much less work has been performed on MCLCPs under nanoconfinement (e.g., incorporating MCLCPs into thin layers less than one μm thick) (Banach M J et al. Macromolecules. 2003, 36(8), 2838-2844; Defaux M et al. Macromolecules. 2009, 42(10), 3500-3509; Sapich B et al. Thin Solid Films. 2006, 514(1-2), 165-173; Vix A et al. Macromolecules. 1998, 31(26), 9154-9159). Since the performance of MCLCPs can depend on their structure, a better fundamental understanding of structure-property relationships for nanoconfined MCLCPs can be used to improve the quality and efficiency of electrical and optical devices using such materials.

The structure, morphology, and thermophysical behaviors of polymers (e.g., crystallization, glass transition, etc.) can be affected by nanoconfinement (e.g., dimensions similar to the size of the molecules). However, most of the studies in this area have been performed on the confinement of glassy or semi-crystalline polymers. The glass transition temperature (T_{g}) of conventional polymers can depend on the film thickness and the nature of interfacial interactions with adjoining materials. For example, the T_{g} of supported polystyrene (PS) thin films can decrease with decreasing film thickness due to the influence of the free surface that can drive enhanced local segmental mobility when compared to bulk (Ellison C J et al. Macromolecules 2005, 38(5), 1767-1778; Ellison C J and Torkelson J M. Nat Mater. 2003, 2(10), 695-700; Keddie J L et al. Europhysics Lett. 1994, 27(1), 59-64). Additionally, studies of poly(methyl methacrylate) (PMMA) thin films on attractive substrates have shown that the Tg can increase with decreasing film thickness due to the interaction between the PMMA chains and the substrate's surface chemistry, which can reduce the local polymer segmental mobility (Grohens Y et al. Langmuir 1998, 14(11), 2929-2932; Grohens Y et al. Eur. Phys. J. E 2002, 8(2), 217-224; Fryer D S et al. Macromolecules 2000, 33(17), 6439-6447). Either interface can dominate the overall or “average” T_{g} of the thin film. For example, the T_{g} of PMMA thin films was found to increase relative to the bulk value when supported on silicon oxide (i.e., attractive substrate dominates over free surface effect) but decrease relative to the bulk value on silicon oxide treated with hexamethyldisilazane (HMDS) (i.e., free surface effect dominates over non-attractive substrate) (Fryer D S et al. Macromolecules 2000, 33(17), 6439-6447). Others have shown that thin film T_{g} behavior can be tuned nearly continuously by incorporating different monomers into copolymers that can modulate interactions between polymer segments and the supporting substrate depending on composition (Mundra M K et al. Polymer 2006, 47(22), 7747-7759).

Besides T_{g} behavior, many semi-crystalline polymer thin films can exhibit different physical properties from those of the bulk materials due to enhanced chain ordering or modified crystal morphologies (Ponting M et al. Macromolecules 2010, 43(20), 8619-8627; Wang H P et al. Macromolecules 2009, 42(18), 7055-7066; Wang HP et al. Science 2009, 323(5915), 757-760). Wang et al. found that poly(ethylene oxide) (PEO) can form two dimensional lamellar crystals rather than three dimensional spherulites when it is confined at the nanoscale, which can affect the transport and optical properties (Wang H P et al. Science 2009, 323(5915), 757-760).

While much research has focused on nanoconfined amorphous or semi-crystalline polymers, a fundamental understanding of the properties of MCLCPs resulting from their nanoconfinement in a constrained geometry and the influence of the interactions of the polymer with surfaces is still lacking. Structure such as liquid crystal ordering, chain packing, and chain orientation could be very different in MCLCP thin films, which can affect their optical, mechanical, and barrier properties compared to those of bulk. With a better understanding of the impact of nanoconfinement and polymer-surface interactions on MCLCP, new opportunities for tuning material properties can arise.

Disclosed herein are liquid crystal polymer (LCP) thin films comprising one or more layers of a liquid crystal polymer (LCP). The LCP can comprise any LCP of interest, including main chain liquid crystal polymers (MCLCPs), side chain liquid crystal polymers (SCLCPs), and combinations thereof The LCP can, in some examples, comprise a block copolymer, branched polymer, dendrimer, elastomer, oligomer, crosslinked material, or a combination thereof, that comprises mesogens. In some examples, the LCP can comprise a random copolyester comprising hydroxybenzoic acid and 2,6-hydroxynaphthoic acid, for example VECTRA™.

Each of the one or more layers can have an average thickness, for example, of 1000 nanometers (nm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 150 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, or 10 nm or less). In some examples, each of the one or more layers comprising the LCP thin film can have an average thickness of 5 nm or more (e.g., 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 150 nm or more, 200 nm or more, 250 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more).

The average thickness of each of the one or more layers can range from any of the minimum values described above to any of the maximum values described above, for example from 5 nm to 1000 nm (e.g., from 5 nm to 500 nm, from 500 nm to 1000 nm, from 5 nm to 250 nm, from 250 nm to 500 nm, from 500 nm to 750 nm, from 750 nm to 1000 nm, from 5 nm to 100 nm, or from 20 nm to 950 nm).

The one or more layers of LCP can, in some examples, exhibit optical anisotropy. In other words, in some examples the layers can be optically anisotropic. For example, the ordinary refractive index (nₒ) (e.g., the in-plane refractive index) can be greater than the extraordinary refractive index (nₑ) (e.g., the out-of-plane refractive index) at one or more wavelengths. In some examples, the ordinary refractive index (nₒ) can greater than the extraordinary refractive index (nₑ) by 5% or more (e.g., 10% or more, 15% or more, 20% or more, 25% or more, 30% or more, 35% or more, 40% or more, 45% or more, 50% or more, 55% or more, 60% or more, 65% or more, 70% or more, or 75% or more) at one or more wavelengths.

The ordinary refractive index (nₒ) of the one or more layers comprising LCP can, for example, be greater than 1 or more (e.g., 1.1 or more, 1.2 or more, 1.3 or more, 1.4 or more, 1.5 or more, 1.6 or more, 1.7 or more, 1.8 or more, 1.9 or more, 2.0 or more, 2.1 or more, 2.2 or more, 2.3 or more, 2.4 or more, 2.5 or more, 2.6 or more, 2.7 or more, 2.8 or more, or 2.9 or more) at one or more wavelengths of interest (e.g., one or more wavelengths from 400 nm to 1000 nm). In some examples, the ordinary refractive index (nₒ) of the LCP thin film can be 3 or less (e.g., 2.9 or less, 2.8 or less, 2.7 or less, 2.6 or less, 2.5 or less, 2.4 or less, 2.3 or less, 2.2 or less, 2.1 or less, 2.0 or less, 1.9 or less, 1.8 or less, 1.7 or less, 1.6 or less, 1.5 or less, 1.4 or less, 1.3 or less, 1.2 or less, or 1.1 or less) at one or more wavelengths of interest (e.g., one or more wavelengths from 400 nm to 1000 nm). The ordinary refractive index (nₒ) of the LCP thin film can range from any of the minimum values described above to any of the maximum values described above. For example, the ordinary refractive index (nₒ) of the LCP thin film can range from greater than 1 to 3 (e.g., from greater than 1 to 2, from 2 to 3, from greater than 1 to 1.5, from 1.5 to 2, from 2 to 2.5 from 2.5 to 3, from 1.5 to 2.5, or from 1.7 to 1.9) at one or more wavelengths of interest (e.g., one or more wavelengths from 400 nm to 1000 nm).

The extraordinary refractive index (nₑ) of the one or more layers comprising LCP can, for example, be greater than 1 or more (e.g., 1.1 or more, 1.2 or more, 1.3 or more, 1.4 or more, 1.5 or more, 1.6 or more, 1.7 or more, 1.8 or more, 1.9 or more, 2.0 or more, 2.1 or more, 2.2 or more, 2.3 or more, 2.4 or more, 2.5 or more, 2.6 or more, 2.7 or more, 2.8 or more, or 2.9 or more) at one or more wavelengths of interest (e.g., one or more wavelengths from 400 nm to 1000 nm). In some examples, the extraordinary refractive index (nₑ) of the LCP thin film can be 3 or less (e.g., 2.9 or less, 2.8 or less, 2.7 or less, 2.6 or less, 2.5 or less, 2.4 or less, 2.3 or less, 2.2 or less, 2.1 or less, 2.0 or less, 1.9 or less, 1.8 or less, 1.7 or less, 1.6 or less, 1.5 or less, 1.4 or less, 1.3 or less, 1.2 or less, or 1.1 or less) at one or more wavelengths of interest (e.g., one or more wavelengths from 400 nm to 1000 nm). The extraordinary refractive index (nₑ) of the layer(s) can range from any of the minimum values described above to any of the maximum values described above. For example, the extraordinary refractive index (nₑ) of the layer(s) can range from greater than 1 to 3 (e.g., from greater than 1 to 2, from 2 to 3, from greater than 1 to 1.5, from 1.5 to 2, from 2 to 2.5 from 2.5 to 3, from 1.5 to 2.5, or from 1.5 to 1.7) at one or more wavelengths of interest (e.g., one or more wavelengths from 400 nm to 1000 nm).

In some examples, the one or more layers of LCP can be substantially optically transparent. For example, the average transmittance of the one or more layers over wavelengths from 400 nm to 750 nm can be 80% or more (e.g., 81% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more, or 99% or more). In some examples, the average transmittance of the one or more layers over wavelengths from 400 nm to 750 nm can be 100% or less (e.g., 99% or less, 98% or less, 97% or less, 96% or less, 95% or less, 94% or less, 93% or less, 92% or less, 91% or less, 90% or less, 89% or less, 88% or less, 87% or less, 86% or less, 85% or less, 84% or less, 83% or less, 82% or less, or 81% or less). The average transmittance of the one or more layers can range from any of the minimum values described above to any of the maximum values described above, for example from 80% to 100% (e.g., from 80% to 90%, from 90% to 100%, from 80% to 85%, from 85% to 90%, from 90% to 95%, from 95% to 100%, or from 85% to 95%).

In some embodiments, the mesogens of the LCP can be aligned within the plane of each of the one or more layers. In some examples, the one or more layers can have an orientational order of 0.05 or more (e.g., 0.1 or more, 0.15 or more, 0.2 or more, 0.25 or more, 0.3 or more, 0.35 or more, 0.4 or more, 0.45 or more, 0.5 or more, 0.55 or more, 0.6 or more, 0.65 or more, 0.7 or more, 0.75 or more, 0.8 or more, 0.85 or more, 0.9 or more, or 0.95 or more). In some examples, the LCP thin films can have an orientational order of 1 or less (e.g., 0.95 or less, 0.9 or less, 0.85 or less, 0.8 or less, 0.75 or less, 0.7 or less, 0.65 or less, 0.6 or less, 0.55 or less, 0.5 or less, 0.45 or less, 0.4 or less, 0.35 or less, 0.3 or less, 0.25 or less, 0.2 or less, 0.15 or less, or 0.1 or less). The orientational order of the one or more layers can range from any of the minimum values described above to any of the maximum values described above, for example from 0.05 to 1 (e.g., from 0.05 to 0.5, from 0.5 to 1, from 0.05 to 0.25, from 0.25 to 0.5, from 0.5 to 0.75, from 0.75 to 1, or from 0.15 to 0.55). The orientational order can, for example, be determined using polarized attenuated total reflection—Fourier transform infrared (ATR-FTIR) spectroscopy.

The one or more layers can, in some examples, have a low oxygen permeability. For example, the one or more layers can have an oxygen permeability of 1×10⁻³ barrer or less (e.g., 9.5×10⁻⁴ barrer or less, 9×10⁻⁴ barrer or less, 8.5×10⁻⁴ barrer or less, 8×10⁻⁴ barrer or less, 7.5×10⁻⁴ barrer or less, 7×10⁻⁴ barrer or less, 6.5×10⁻⁴ barrer or less, 6×10⁻⁴ barrer or less, 5.5×10⁻⁴ barrer or less, 5×10⁻⁴ barrer or less, 4.5×10⁻⁴ barrer or less, 4×10⁻⁴ barrer or less, 3.5×10⁻⁴ barrer or less, 3×10⁻⁴ barrer or less, 2.5×10⁻⁴ barrer or less, 2.4×10⁻⁴ barrer or less, 2.3×10⁻⁴ barrer or less, 2.2×10⁻⁴ barrer or less, 2.1×10⁻⁴ barrer or less, 2.0×10⁻⁴ barrer or less, 1.9×10⁻⁴ barrer or less, 1.8×10⁻⁴ barrer or less, 1.7×10⁻⁴ barrer or less, or 1.6×10⁻⁴ barrer or less). In some examples, the one or more layers can have an oxygen permeability of 1.5×10⁻⁴ barrer or more (e.g., 1.6×10⁻⁴ barrer or more, 1.7×10⁻⁴ barrer or more, 1.8×10⁻⁴ barrer or more, 1.9×10⁻⁴ barrer or more, 2.0×10⁻⁴ barrer or more, 2.1×10⁻⁴ barrer or more, 2.2×10⁻⁴ barrer or more, 2.3×10⁻⁴ barrer or more, 2.4×10⁻⁴ barrer or more, 2.5×10⁻⁴ barrer or more, 3×10⁻⁴ barrer or more, 3.5×10⁻⁴ barrer or more, 4×10⁻⁴ barrer or more, 4.5×10⁻⁴ barrer or more, 5×10⁻⁴ barrer or more, 5.5×10⁻⁴ barrer or more, 6×10⁻⁴ barrer or more, 6.5×10⁻⁴ barrer or more, 7×10⁻⁴ barrer or more, 7.5'10⁻⁴ barrer or more, 8×10⁻⁴ barrer or more, 8.5×10⁻⁴ barrer or more, 9×10⁻⁴ barrer or more, or 9.5×10⁻⁴ barrer or more).

The oxygen permeability of the one or more layers can range from any of the minimum values described above to any of the maximum values described above. For example, the one or more layers can have an oxygen permeability of from 1.5×10⁻⁴ barrer to 1×10⁻³ barrer (e.g., from 1.5×10⁻⁴ barrer to 6×10⁻⁴ barrer, from 6×10⁻⁴ barrer to 1×10⁻³ barrer, from 1.5×10⁻⁴ barrer to 3.5×10⁻⁴ barrer, from 3.5×10⁻⁴ barrer to 5.5×10⁻⁴ barrer, from 5.5×10⁻⁴ barrer to 7.5×10⁻⁴ barrer, from 7.5×10⁻⁴ barrer to 1×10⁻³ barrer, or from 2.1×10⁻⁴ barrer to 1×10⁻³ barrer). In some examples, the one or more layers can be substantially impermeable to gas diffusion. In some examples, the one or more layers can have a gas permeability comparable to, or better than, a metallized film.

In some examples, the one or more layers can be supported by a substrate. The substrate can comprise any suitable material, for example, polymers (e.g., polypropylene), silicones, glasses, ceramics, inorganic materials, semiconductor materials (e.g., silicon), metals, and combinations thereof.

In some examples, the T_{g} of the one or more layers supported by a substrate can increase as the thickness of the one or more layers decreases. In some examples, the T_{g} of the one or more layers supported by the substrate can be greater than the T_{g} for the bulk LCP (e.g., a layer of LCP with a thickness greater than 1 μm).

In some examples, the T_{g} of the one or more layers supported by a substrate can decrease as the thickness of the one or more layers decreases. In some examples, the T_{g} of the one or more layers supported by a substrate can be less than the T_{g} for the bulk LCP (e.g., a layer of LCP with a thickness greater than 1 μm).

In some examples, the composition can comprise an LCP thin film comprising one layer of the LCP with a thickness of 1000 nm or less.

Also disclosed herein are methods of making the compositions disclosed herein. The methods can comprise forming the LCP thin layers, for example by spin coating, melt processing, coextruding, or a combination thereof, the one or more layers of the LCP.

In general, there are different methods to introduce nanoconfinement to a polymer system, including, but not limited to multilayer films from coextrusion and thin/ultrathin films from spin coating. Multilayer coextrusion is a melt state process and can be scaled up. Spin coating thin films can quickly prepare samples.

Layer multiplying coextrusion can be used to obtain assemblies with thousands of polymer nanolayers (Ponting M et al. Macromolecular Symposia. 2010, 294(1), 19-32). Polymer melts are combined in an AB feedblock, after which the melt stream flows through a series of layer-multiplying die elements; each element splits the melt vertically, spreads it horizontally, and finally recombines it with twice the number of layers. Layer multiplying coextrusion does not require a solvent during processing or specialized synthesis. This process can be used to combine two or three polymers into a continuous alternating layered structure, with individual layer thickness down to 10 nm, which allows for long range, almost defect free layers for studying the nanoconfinement effect on polymer structures. Multilayer coextrusion is known in the art. See, for example, U.S. Patent Application No. 2014/0327174, U.S. Pat. No. 8,778,245, and U.S. Patent Application No. 2010/0143709, which are hereby incorporated by reference for their teaching of multilayer coextrusion methods.

The coextrusion process, which operates with readily available polymer materials, can be used to fabricate nanoscale polymeric structures in sufficient quantities to probe structure-property relationships resulting from nanoscale confinement. Given that nanoconfinement is introduced into multilayer films, bulk characterization tools can be used to fundamentally study nanoconfined polymers. For design and execution of packaging strategies, polymer nanolayers with enhanced barrier properties can be incorporated into conventional polymeric films to achieve the right barrier properties for less cost, which in turn could reduce the impact to the environment and energy consumption.

Thin films produced by spin coating are good candidates for fundamentally studying the structure and properties of confined polymer systems in a laboratory scale setting. Uniform thin films from fractions of a nanometer to several micrometers in thickness can be made from the spin coating process. In this technique, a solution which contains a polymer and a solvent is applied to the center of a flat substrate. The spin coater rotates the substrate at high speed in order to spread the fluid through centrifugal force. Because the solvent is volatile and evaporates during spinning, a thin layer of solid polymer will be left on the substrate.

Many nanoconfined films can be made with small quantities (less than 1 gram) of polymer via spin coating. Moreover, spin coated films can be easily made on various substrates, which can be used to study the effect of interfacial interactions on structure and properties of thin films. In contrast, coextrusion processes are designed to process commercially available materials and require a minimum of several hundred grams of materials for one process run. This technique can be used for large scale industrial applications or studies that require large quantities of films.

Also disclosed herein are methods of using the compositions disclosed herein. The compositions described herein can be used in a variety of applications, including, but not limited to, high performance gas barriers, gas separation membranes (e.g., for gas water separation), solar cells, fuel cells, electronic devices, optical devices, coatings, standalone films, laminates, as active layers in multilayer films, food packaging, and the like, or combinations thereof. Also disclosed herein are gas barriers comprising any of the compositions described herein. Also disclosed herein are food packaging materials comprising any of the compositions described herein.

The examples below are intended to further illustrate certain aspects of the methods and compounds described herein, and are not intended to limit the scope of the claims. cl EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

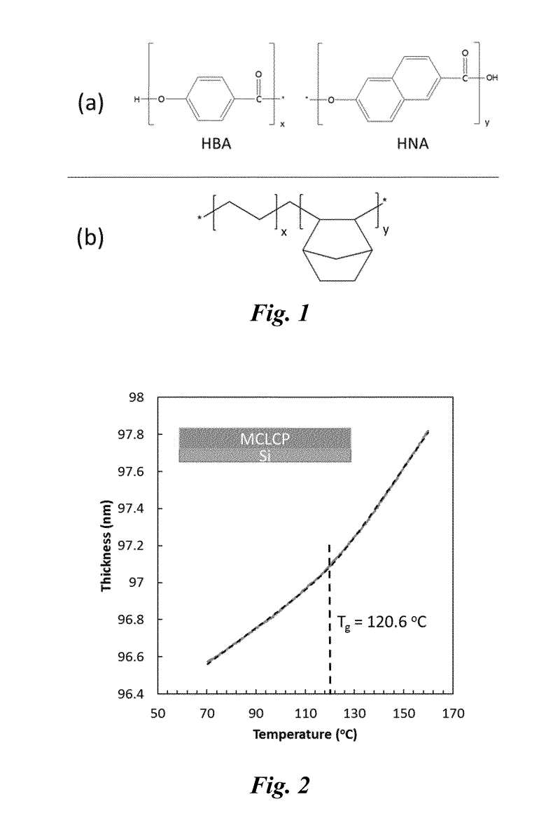

A random copolyester composed mainly of hydroxybenzoic acid (HBA) and 2,6-hydroxynaphthoic acid (HNA) with a bulk glass-to-liquid crystal transition temperature around 109° C. (FIG. 1a) (Guo T et al. Polymer Engineering & Science 2005, 45(2), 187-197), was obtained from Celanese (Celanese Engineered Materials, USA). This random copolyester (HBA-HNA-MCLCP) is a proprietary grade MCLCP and was used under a materials transfer agreement. TOPAS™ poly(ethylene-co-norbornene) (PEN, FIG. 1b), an amorphous copolymer of ethylene and norbornene with a glass transition temperature around 180° C., was purchased from Polysciences, Inc. 3, 5-bis(trifluoromethyl)phenol (>95%) (BTFMP) was purchased from Oakwood Products Inc., and was used as received.

Thick films (l>25 μm) were prepared by casting from solution onto a clean silicon substrate. BTFMP was used as the solvent. For films prepared on silicon wafers, a metal casting ring was used to contain the polymer solution, and a glass cover plate was placed atop the casting ring to retard solvent evaporation and avoid dust contamination. After the polymer solutions were poured onto the substrate, they were allowed to dry for 3-5 days in a fume hood to evaporate the solvent. After removal from the substrate, the films were placed in a vacuum oven at 90° C. to remove residual solvent for at least 24 hours, and then annealed at 150° C. for 2 hours before the permeation tests.

HBA-HNA-MCLCP thin films with submicron thickness were prepared by spin coating polymer solutions in 3,5-bis(trifluoromethyl)phenol (BTFMP) (>95%, Oakwood Products, Inc.). The polymer solution was filtered through Teflon syringe filters with pore sizes of 0.45 μm, 0.2 μm, and 0.1 μm. In some cases, multiple filtration was applied. The spin coating process was performed in a clean room.

Due to the high boiling point of the 3,5-bis(trifluoromethyl)phenol (approximately 176° C.), an infrared lamp was installed to heat the substrate in the spin coating chamber to accelerate solvent evaporation. The temperature of the substrate was about 60° C. as measured by a non-contact infrared thermometer. The film thickness was controlled by varying solution concentration.

Single-side-polished silicon wafers were used as deposition substrates for spin coated samples, including those for ellipsometry and atomic force microscopy. Silicon wafers were piranha treated with a volume ratio of 1:3 30% hydrogen peroxide to 98% sulfuric acid and then stored in deionized water before being used. Prior to use, the silicon wafers were cleaned with isopropanol (e.g., bath sonication in isopropanol for 5 minutes at room temperature), optionally rinsed with deionized water, and then blown dry with filtered air.

A 100 μm thick polypropylene (PP) sheet was used as the substrate for attenuated total reflection infrared spectroscopy. The PP sheet was rinsed with deionized water and isopropanol before use. Cleaned PP substrates were then treated with oxygen plasma (Harrick Plasma, PDC-32G). Plasma treatment can improve adhesion of the adjoining thin film by oxidizing the PP sheet surface.

Ellipsometric data were acquired with a variable angle spectroscopic ellipsometer (J.A. Woollam Company) of the rotating analyzer type. All measurements were performed in air for multiple angles of incidence in the range of 55°-65°. Analysis of the ellipsometric data was performed using CompleteEASE software (J.A. Woollam Company). A uniaxial model, which distinguishes between light propagating parallel and perpendicular to the surface normal, was used in the fitting process to obtain the thickness and optical constants of the polymer thin film.

An Agilent 5500 Atomic Force Microscope was used in tapping mode to characterize the thin film morphology. Atomic Force Microscopy (AFM) images were obtained using 300 series tapping mode AFM tips from Ted Pella with a resonant frequency of 300 kHz and a force constant of 40 N/m.

Water contact angles were measured with a Ramé-Hart NRL C.A. goniometer (Model #100-00). Prior to measurement, each film was rinsed thoroughly with deionized water then blown dry with filtered air.

Attenuated total reflection—Fourier transform infrared (ATR-FTIR) spectra were collected on a Thermo Scientific Nicolet 6700 FTIR equipped with a diamond ATR crystal. An IR wire grid Zn—Se polarizer purchased from Edmund Optics was used to generate polarized IR light. Samples were run for 256 scans with a 4 cm⁻¹ resolution to obtain sufficient signal-to-noise ratio.

The absorption intensities were obtained by integrating the area under the absorption band and the orientational order (f) was calculated from the ratio of the absorption with polarization parallel (A_{∥}) and perpendicular (A_{⊥}) to a reference direction using the following equation:

$$f = \frac{( {A}_{∥} \text{/} {A}_{⊥} ) - 1}{( {A}_{∥} \text{/} {A}_{⊥} ) + 2} \qquad ( 1 )$$

Ultraviolet-visible (UV-VIS) transmittance measurements were performed on a Thermo Scientific Evolution 220 UV-Vis spectrometer. The spectra were collected under ambient conditions.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Thin films of main chain liquid crystalline polymers (MCLCPs) with thicknesses of several hundred nanometers or less can be used as standalone films, laminates or active layers within multilayer structures for applications ranging from high performance packaging membranes to microelectronic devices.

The nanoconfinement effects in MCLCP thin films were studied by examining HBA-HNA-MCLCP, a commercial grade MCLCP with attractive properties and commercial availability. MCLCP thin films with thicknesses from 20 nm to 1 pm were spin coated onto a variety of substrates. This is the first time that thin/ultra-thin films of

MCLCPs have been made by spin coating due to their poor solubility in common solvents. This film preparation method allowed the nanoconfined ordering and thermophysical properties of thermotropic MCLCP thin films to be investigated. The glass to liquid crystal transition temperature (T_{g}) of these MCLCP thin films was investigated by ellipsometry. It was found that the T_{g} was affected by the film thickness as well as the nature of the interaction with the substrate. In addition, results from infrared spectroscopy revealed that the MCLCP chains aligned parallel to the substrate due to the geometric constraints imposed by the film boundaries. An associated consequence of the alignment of MCLCP chains in nanoconfined films is that they exhibited optical anisotropy, which can be useful for applications in optical devices.

Many of the physical properties (mechanical, viscoelastic, diffusive, transport, etc.) of polymers can depend on their T_{g} (Han J et al. Macromolecules 1994, 27(26), 7781-7784). For the MCLCP used in this study, T_{g} defines the onset of a liquid crystal phase: the polymer is in a solid, glassy state at temperatures below its T_{g}, while it forms ordered structures in a liquid crystal state above its T_{g}. Many of the interesting properties of MCLCPs are due to their unique liquid crystal structures, and as a consequence, the role of nanoconfinement on the T_{g} of MCLCP thin films was investigated.

FIG. 2 shows an ellipsometric temperature scan obtained for a HBA-HNA-MCLCP thin film supported on a silicon wafer with a native oxide layer. The thin film samples were annealed at 160° C. in a vacuum oven for 24 hours prior to the measurement. In the glassy state, the thermal expansion coefficients are different from that of the liquid crystal state. The transition between the glass and liquid crystal state can be approximated by a tanh function and the T_{g} can be calculated by the following empirical expression (Dalnoki-Veress K et al. Phys Rev E 2001, 63(3), 031801):

$$h ( T ) = w ( \frac{M - G}{2} ) ln [ cosh ( \frac{T - {T}_{g}}{w} ) ] + ( T - {T}_{g} ) ( \frac{M + G}{2} ) + c \qquad ( 2 )$$

where h is the film thickness, T is the temperature, w is the width of the transition between the glass and liquid crystal state, c is the film thickness when T=T_{g}, and M and G are the dh/dT values in the liquid crystal state and the glass state, respectively. The value of T_{g} was obtained by fitting h(T) to Equation (2). The least squares fitting of this function to the experimental data was used to reduce any ambiguity associated with determining T_{g}.

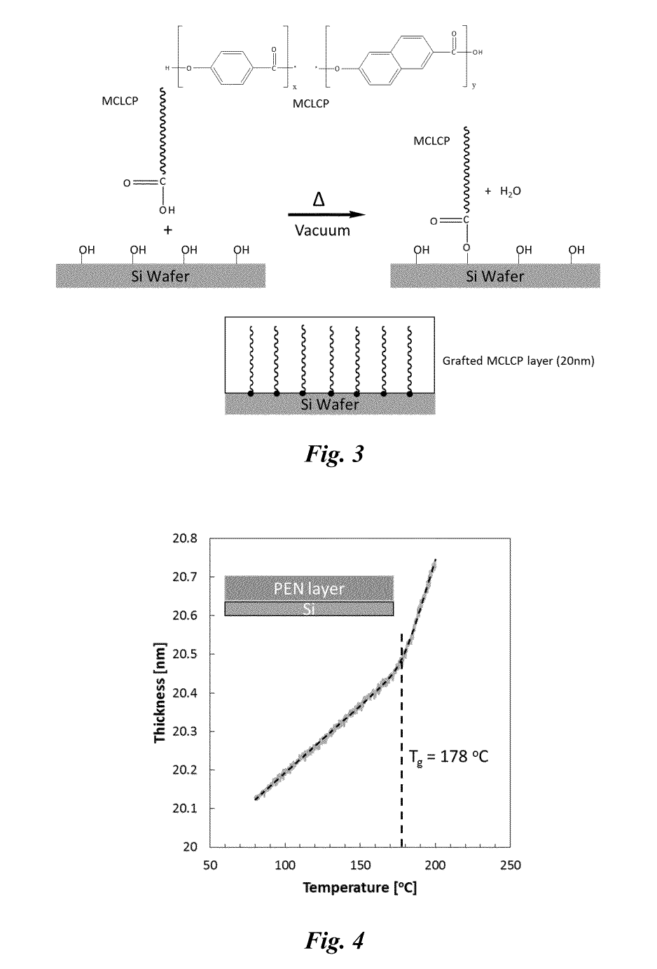

As shown in FIG. 2, the film with thickness around 90 nm exhibits a T_{g} at 120.6° C., which is higher than that of the bulk material (˜109° C.). This result indicates an interaction between the thin film and the silicon wafer substrate, which reduced the segmental mobility of the polymer chains and thereby increased the overall T_{g} of the thin film (Labahn D et al. Phys Rev E 2009, 79(1), 01801; Yin H et al. Macromolecules 2012, 45(3), 1652-1662). As illustrated in FIG. 3, when the samples were annealed under vacuum, the carboxyl end groups of the MCLCP chain can react with the hydroxyl groups on the silicon wafer by eliminating the H₂O generated by the reaction. As a result, the MCLCP chains were covalently grafted onto the surface of the silicon wafer, as evidenced by the presence of a thin residual layer after washing by 3,5-bis(trifluoromethyl)phenol repeatedly. In order to confirm this residual layer was covalently bonded to the surface, another thin film sample with similar thickness was annealed at the same temperature but without vacuum. The thin film after annealing without vacuum was washed off by solvent and no residual layer was detected on the silicon wafer by ellipsometry. In addition, the washed thin film samples that had been annealed under vacuum were sonicated for different amounts of time in 3,5-bis(trifluoromethyl)phenol at 60° C. The ellipsometric value of the thickness of the residual layer after sonication remained constant regardless of the sonication time. This demonstrates that the standard solvent washes removed all the ungrafted polymers and that the polymer in the residual layer is truly grafted (as opposed to just hydrogen bonded) to the surface.

To further explore the impact of the underlying substrate chemistry, a PEN copolymer layer (Figure lb) was introduced as an underlying layer to the MCLCP to eliminate the interfacial interaction between the MCLCP thin film and the silicon wafer substrate. PEN is an amorphous polymer with a bulk T_{g} of around 180° C. A 20 nm thick PEN layer was spin coated from solution in toluene onto the silicon wafer. This can eliminate the interfacial interaction by burying the hydroxyl groups on the surface of silicon substrate. The PEN thin film was washed with 3,5-bis(trifluoromethyl)phenol several times to verify that the thickness of the PEN layer remained constant, which confirmed that PEN is not soluble in the fluorinated solvent. As shown in the FIG. 4, the T_{g} of the 20 nm thick PEN thin film was measured to be about 178° C. by ellipsometry, which is higher than the temperature range of interest in this study (e.g. less than 160° C.). Hence, the PEN underlayer can retain its glassy, hard substrate character with respect to the MCLCP overlayer throughout all the experiments. In addition, the water contact angle of the PEN film was measured to be about 86°, which can imply a relatively low surface energy and a nonattractive interfacial interaction with the MCLCP.

As shown in FIG. 5, when a ˜90 nm thick MCLCP thin film was spin coated on top of the PEN layer and then subjected to the same annealing procedure (e.g., 160° C. under vacuum), the T_{g} of the MCLCP thin film was determined to be around 101.2° C., almost 10° C. lower than the bulk value. Such a reduction in T_{g} can be attributed to the presence of a free surface layer in the MCLCP thin film that can promote higher local segmental mobility compared to bulk and can dominate over any effect caused by the adjoining PEN layer as the film is made thinner (Forrest J A et al. Phys Rev E 1997, 56(5), 5705-5716).

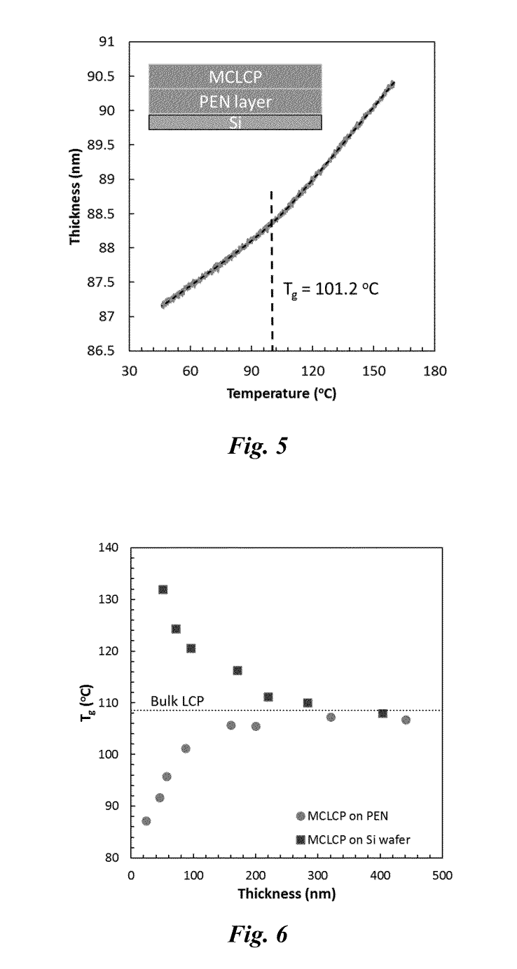

FIG. 6 shows the T_{g} of MCLCP thin films on silicon wafer and PEN substrates as a function of MCLCP film thickness. When the MCLCP film was supported on a glassy PEN underlying layer, the T_{g} decreased monotonically with decreasing film thickness, which can be ascribed to enhanced segmental mobility at the free interface (Ellison C J et al. Macromolecules 2005, 38(5), 1767-1778; Ellison C J and Torkelson J M. Nat Mater. 2003, 2(10), 695-700). However, when supported on the silicon wafer with native oxide, the T_{g} of the MCLCP thin films increased with decreasing film thickness due to the formation of a substrate grafted layer with lowered segmental mobility, which can dominate the free surface effects and can cause an overall increase in film T_{g}. When the thickness of the MCLCP thin film was decreased, the portion of the film comprised of the grafted layer (or free surface layer) increased, resulting in higher (or lower) T_{g} values, respectively. These results are similar to those reported by Nealey et al., who found an elevation of T_{g} for grafted PS (Tate R S et al. J Chem Phys. 2001, 115(21), 9982-9990). For both MCLCP cases in FIG. 6, the onset of deviations from the bulk T_{g} appear to be in the range of 150-200 nm, which is much greater than typically reported for other supported polymers.

This result indicates that the T_{g} can be controlled within a very a temperature range, such as from 80° C. to 130° C., by altering the film thickness and interfacial interactions of the adjoining layers/substrates. As mentioned before, the mechanical and transport properties of polymers can depend on their T_{g}, thus the understanding of T_{g} behavior in nanoconfined MCLCPs can enable new methods to optimize or control the properties of MCLCPs.

A study of the structural ordering of the MCLCP in thin films was undertaken as many of the properties of MCLCPs can originate from their structural ordering characteristics. Furthermore, based on previous studies of crystallizable polymers, this structure can be influenced by nanoconfinement. In order to eliminate grafting reactions and their effect on the alignment of the polymer chains, all the thin films discussed in this example were supported on a PEN underlayer.

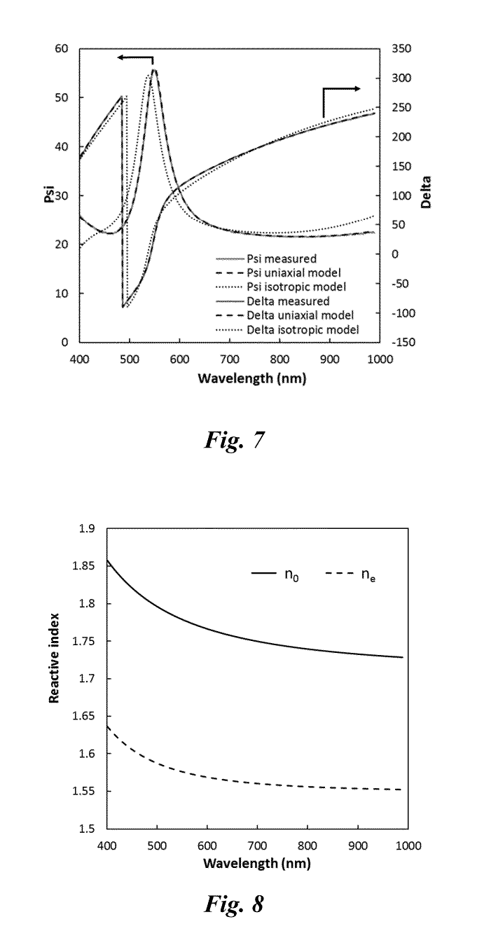

Ellipsometry has been widely used to develop insight regarding the orientational order of polymers in thin films through detection of anisotropic light propagation characteristics. FIG. 7 shows an example of ellipsometry data for a MCLCP thin film, as well as the fit results using an isotropic and uniaxial model. The uniaxial model distinguishes between propagation of light parallel and perpendicular to the film surface, and can therefore be used to characterize polymer thin films with anisotropic structure (Tammer M et al. Adv Funct Mater. 2002, 12(6-7), 447-454; Tammer M et al. Adv Mater. 2002, 14(3), 210-212). The isotropic model is usually only suitable for homogeneous polymeric materials without any anisotropic orientational ordering (Losurdo M et al. Macromolecules 2003, 36(12), 4492-4497). As illustrated in FIG. 7, the isotropic model does not fit the ellipsometry results of MCLCP thin films well, but the uniaxial model does fit the ellipsometry results of MCLCP thin films well. This can indicate that anisotropic structure is present in the MCLCP thin film with chain segments favoring orientation either parallel or perpendicular to the substrate.

FIG. 8 shows the (in-plane) ordinary (nₒ) and (out-of-plane) extraordinary (nₑ) refractive index obtained by the uniaxial model of a MCLCP thin film with a thickness around 100 nm. The optical anisotropy indicates uniaxial ordering: a larger dispersion of refractive index was found for the in-plane direction (nₒ), revealing that the optical axis of the MCLCP polymer chain segments is aligned parallel to the substrate surface within the thin film. Noting that this MCLCP is typically composed of nematically ordered rigid mesogens (Guo T et al. Polymer Engineering & Science 2005, 45(2), 187-197) and the optical axis of nematic polymer chain segments is parallel to its molecular long axis (Hikmet R A M et al. Macromolecules 1992, 25(16), 4194-4199; Anderle K et al. Die Makromolekulare Chemie, Rapid Communications 1989, 10(9), 477-483), such optical anisotropy is indicative of parallel orientation of the MCLCP chains to the substrate surface.

The birefringence (Δn), which is defined as the difference between the two refractive indices, can be an important property of optical films (e.g., retardation and protective films in optical devices) (Nobukawa S et al. Polymer 2014, 55(15), 3247-3253; Uchiyama A et al. Polym J 2012, 44(10), 995-1008). The ability to achieve high Δn in MCLCP thin films can promote their applications in high performance display devices such as three dimensional (3-D) and organic electro luminescence (EL) displays, which require a quarter waveplate with well-controlled Δn (Nobukawa S et al. Polymer 2014, 55(15), 3247-3253; Yamaguchi Metal. Cellulose 2012, 19(3), 601-613).

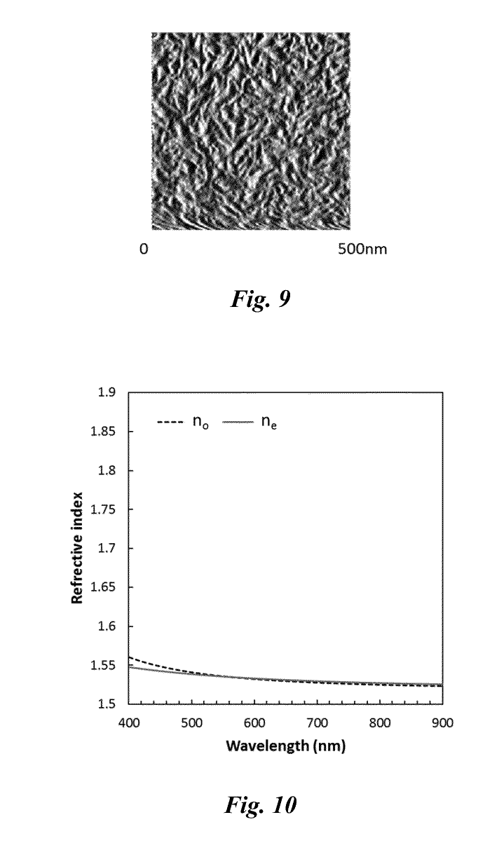

No significant difference was found in the ellipsometry results when the samples were rotated along the substrate normal, suggesting that the chains lie parallel to the surface but are randomly oriented azimuthally in the plane direction. This is consistent with the AFM images (FIG. 9); the needle like liquid crystal domains lie flat to the surface, but in the plane direction, no specific orientation can be observed.

To confirm that the difference in refractive index was due to chain orientation in the thin film samples and not a result of the uniaxial model itself, an ellipsometry measurement of a 100 nm thick amorphous PEN thin film, which is not expected to possess any orientational order, was taken. The ellipsometry data of the PEN thin film was fit using the uniaxial model and its refractive indices were extracted from the model. As shown in FIG. 10, no significant difference in ordinary and extraordinary refractive index was observed for the PEN thin film. This result confirms that the difference in the refractive index observed for the MCLCP thin film samples is indeed indicative of chain orientation in the MCLCP thin film samples, which can be due to the more rigid chain and liquid crystal structuring of the MCLCP compared to PEN.

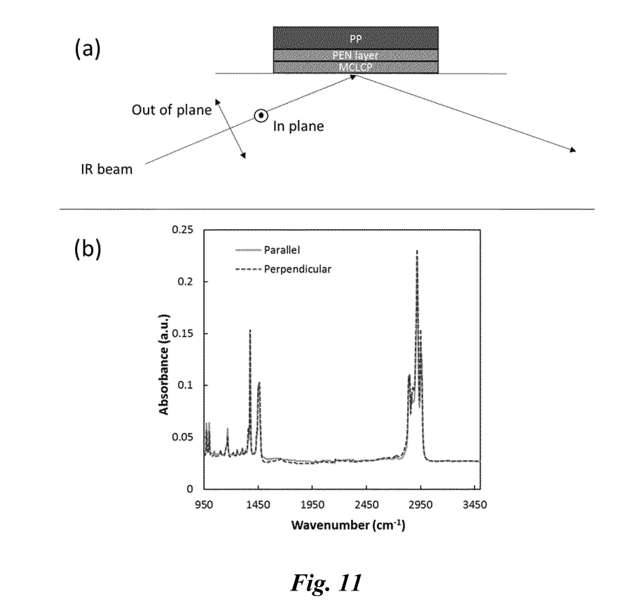

Polarized ATR-FTIR was performed to confirm and quantitatively estimate the orientational order of the MCLCP thin films. As shown in FIG. 11a, the infrared light is polarized to the direction parallel (in-plane) and perpendicular (out-of-plane) to the thin film surface, and the dichroic ratio (A_{∥}/A_{⊥}) was used to characterize the ‘in-plane’ orientational order of polymer chains (Wang X et al. Macromolecules 2011, 44(24), 9731-9737; Lee D H et al. Macromolecules 2007, 40(17), 6277-6282). In order to obtain reliable results from polarized ATR-FTIR, a soft substrate is needed to ensure perfect contact of thin film samples (e.g., MCLCP on top of PEN) with the ATR crystal. Therefore, thin film samples of MCLCP on PEN were spin coated and annealed on a salt plate, then floated off in water onto a PP sheet. This three layer film (i.e., MCLCP-PEN-PP) was dried at 80° C. for 12 hours prior to use.

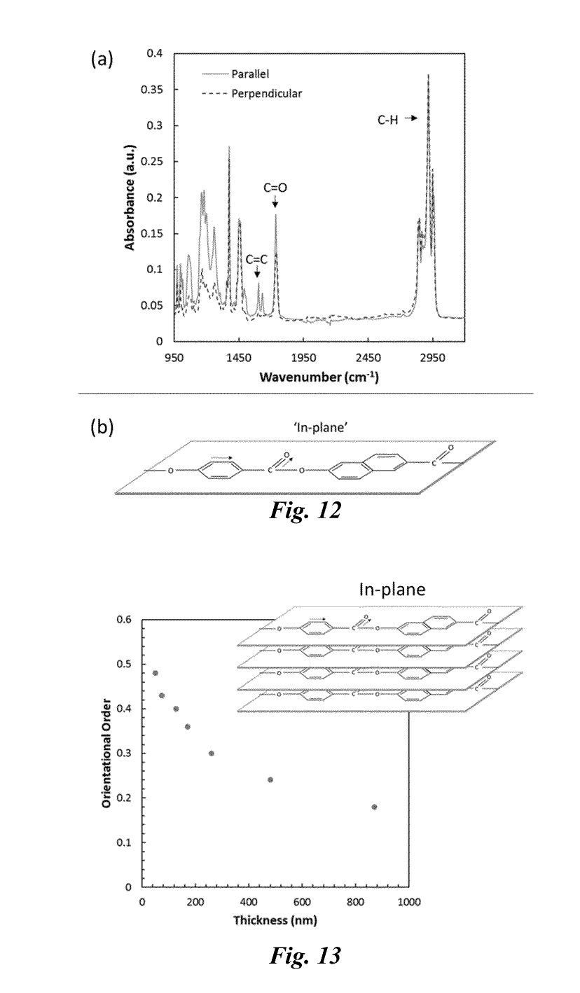

FIG. 11b shows the polarized ATR-FTIR results of a PEN thin film supported on a PP sheet. No apparent difference in the absorbance for A_{∥} and A_{⊥} was observed, which revealed that the PEN underlayer and PP sheet do not possess any orientational order, and thus any detected orientational order in subsequent experiments must only exist in the MCLCP thin film. FIG. 12 shows a representative polarized ATR-FTIR result of a 70 nm MCLCP thin film with a PEN underlayer supported on a PP sheet. The spectra were normalized by the 2920 cm⁻¹ band that is assigned to the CH₂ vibration in the PP main chain and is insensitive to the orientation (Morent Ret al. Surface and Interface Analysis 2008, 40(3-4), 597-600). The absorption band around 1602 cm⁻¹, which is assigned to the (—C═C—) stretching vibration of the naphthalene rings in the polymer backbone, was used to characterize the chain orientation of the MCLCP thin film (Branciforti MC et al. J Appl Polymer Sci. 2006, 102(3), 2241-2248). The absorbance associated with 1602 cm⁻¹ is stronger with parallel polarization, indicating that the MCLCP main chains are aligned parallel to the film surface with an orientational order f of 0.43 calculated by Equation (1). Meanwhile, the carbonyl group stretching vibration (1750 cm⁻¹) peak also exhibits stronger absorption in the direction parallel to the surface, implying that the polymer chains are lying flat with an ‘in-plane’ structure (FIG. 12). FIG. 13 shows the in-plane orientational order (calculated from the dichroic ratio of the —C═C— stretching vibration peak at 1602 cm⁻¹) of MCLCP thin films as a function of film thickness. The in-plane orientational order of MCLCP polymer chains increases as the confining film thickness decreases. This thickness dependent anisotropic orientation can be due to the effect of confinement on the rigid rod-like MCLCP chains. In the MCLCP thin films, the available conformations for the stiff chains are restricted in nanoconfined geometries. Moreover, reduction of the dimension in the direction normal to the film surface can force the rod-like MCLCP chains to lie flat in the film plane. Therefore, the enhanced in-plane, anisotropically aligned structures of the MCLCP polymer backbone with decreasing film thickness can be due to the geometric confinement.

In sum, the T_{g} of the thin film was affected by the film thickness and interfacial interactions with the substrate, with either increases (silicon wafer substrates) or decreases (polymeric substrates) in T_{g}. Additionally, it was found that the MCLCP polymer chains were aligned parallel to the substrate surface with an ‘in-plane’ structure. The polymer chains were anisotropically lying flat on the substrate surface but randomly aligned azimuthally within the plane. Moreover, the orientational order increased with decreasing film thickness due to the effect of nanoconfinement on the rigid rod-like polymer chains in confined geometries. These observations demonstrate that the MCLCP chain alignment can be influenced by nanoscale confinement, which can be due to size constraints. These phenomena can be used to tune application relevant properties of these materials by controlling film thickness and interfacial interactions with adjoining materials.

### Example 2

Liquid crystalline polymers (LCPs) are very attractive candidates for barrier films and high performance membranes due to their gas/water barrier properties, chemical resistance and mechanical strength. Paul and coworkers have found that commercial grade main chain LCPs possess more than 2 orders of magnitude lower gas permeability than many conventional polymer packaging materials such as polypropylene, polyethylene terephthalate (PET) and nylon (Weinkauf D H and Paul D R. J Polymer Sci Part B: Polymer Phys. 1992, 30(8), 817-835; Weinkauf D H and Paul D R. J Polymer Sci Part B: Polymer Phys. 1992, 30(8), 837-849). Such low gas permeability of LCPs has been attributed to their chain packing structure in the nematic liquid crystal phase (Weinkauf D H and Paul D R. J Polymer Sci Part B: Polymer Phys. 1992, 30(8), 817-835). LCP films with high barrier properties present potential applications in food packaging (Miller K S and Krochta J M. Trends in Food Sci & Tech. 1997, 8(7), 228-237), flexible electronic devices (Nogi M et al. Adv Mater. 2009, 21(16), 1595-1598) and fuel cells (Paul D R and Robeson L M. Polymer. 2008, 49(15), 3187-3204).

The thermophysical properties and chain packing structure of polymer materials can be affected by nanoconfinement. However, the studies in this area have been performed on the confinement of amorphous or semi-crystalline polymers. A comprehensive understanding of the properties of nanoconfined LCPs is still lacking. The effect of nanoconfinement on the structure and barrier properties of HBA-HNA-MCLCP was investigated. Thin films with different thickness were fabricated by spin coating. The gas barrier properties of the nanoconfined LCP were investigated by measuring the O₂ permeability of the thin film samples.

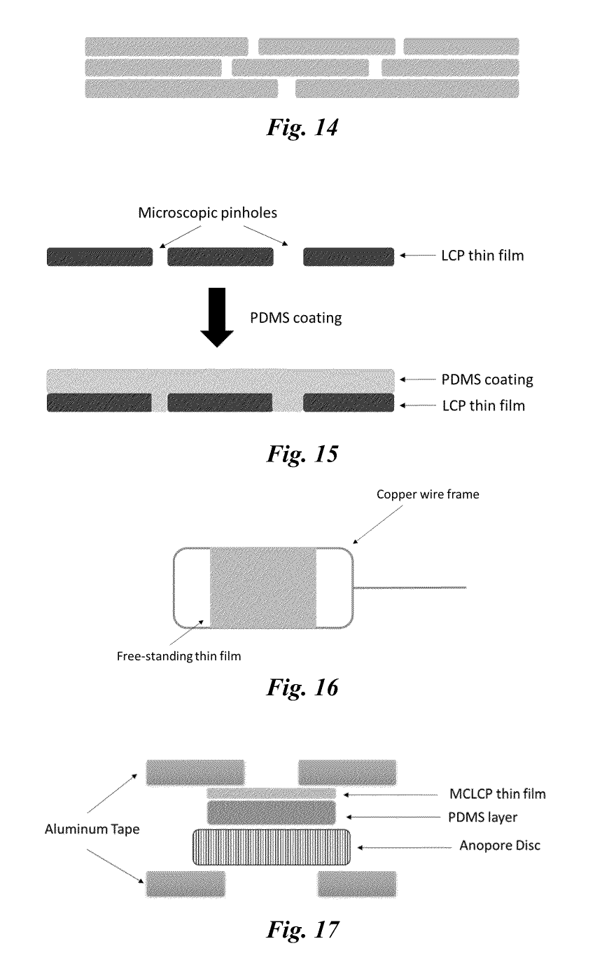

A major challenge in studying the gas permeability of polymer thin films is the presence of microscopic pinhole defects induced during the spin coating process (Rowe B W et al. Polymer. 2009, 50(23), 5565-5575; Rowe B W et al. Polymer. 2010, 51(16), 3784-3792). Several strategies were employed to circumvent the pinhole problems in the permeability measurement. First of all, the thin films were prepared by a multiple cycle spin coating method, which was found to be very effective in eliminating the pinhole defects (Ke X B et al. Adv Mater. 2007, 19(6), 785-790; Fan Z and Harrison D J. Anal Chem. 1992, 64(11), 1304-1311; Youl Bae H and Man Choi G. Sensors and Actuators B: Chem. 1999, 55(1), 47-54). In between subsequent spin coating processes, the film was placed inside an oven at 80° C. under vacuum for 2 mins to partially remove residual solvent and solidify the thin film. As shown in FIG. 14, deposition of the subsequent layers can effectively overlap the pinhole defects of the existing underlying layer, thus suppressing the impact of the pinholes on the gas permeability of thin films.

Additionally, a poly(dimethylsiloxane) (PDMS) coating technique was used to reduce the effect of pinholes on the permeability results (Rowe B W et al. Polymer. 2009, 50(23), 5565-5575; Rowe B W et al. Polymer. 2010, 51(16), 3784-3792; Murphy T M et al. Polymer. 2013, 54(2), 873-880). After spin coating a thin HBA-HNA-MCLCP film with multiple cycles, a thin layer of highly permeable, flexible PDMS was spin coated from solution in toluene directly on top of the HBA-HNA-MCLCP thin film. HBA-HNA-MCLCP is not soluble in toluene, hence the spin coating process of the PDMS layer does not affect the HBA-HNA-MCLCP under layer. The bilayer film was then baked at 120° C. for 5 min to crosslink the PDMS and remove residual solvent (FIG. 15). The PDMS layer can block convective flow through any pinhole defects of the HBA-HNA-MCLCP layer and provide extra ease of handling. According to the series model, the permeability of the PDMS/ HBA-HNA-MCLCP bilayer film is given by the following equation,

$$\frac{{I}_{bilayer}}{{P}_{bilayer}} = \frac{{I}_{MCLCP}}{{P}_{MCLCP}} + \frac{{I}_{PDMS}}{{P}_{PDMS}} \qquad ( 3 )$$

where l_{bilyaer}, l_{MCLCP} and l_{PDMS} are the thickness of the bilayer, HBA-HNA-MCLCP and PDMS layer, respectively; P_{bilyaer}, P_{MCLCP} and P_{PDMS} are the permeability of the bilayer, HBA-HNA-MCLCP and PDMS, respectively. The PDMS top coat layer was around 4 μm thick measured by a Dektak 6 M Stylus Profilometer and its O₂ permeability was reported to be approximately 933 barrer (1 barrer=10⁻¹⁰ cm³ cm cm⁻² s⁻¹ cm Hg⁻¹) (McCaig M S and Paul D. Polymer. 2000, 41(2), 629-637), while the HBA-HNA-MCLCP layer was thicker than 100 nm with a permeability less than 1×10⁻³ barrer (U.S. Pat. No. 6,294,640; McKeen L W. Film Properties of Plastics and Elastomers. William Andrew: Waltham, M A, 2012). The contribution of the PDMS top coat to the total permeation resistance is less than 0.01% calculated by Equation (3), and can be therefore neglected on the permeation measurement.

Polymer film samples were prepared for permeation testing by mounting them between two discs of aluminum tape. The tape discs were punched from an aluminum tape using an arc punch that was similar in size to the permeation cell sample holder. In order to permit gas permeation through the polymer films, circular holes of a known diameter were cut from the center of the tape discs using an arc punch.

The sample preparation method for permeability measurement has been described elsewhere by Huang and Paul (Huang Y and Paul D R. Polymer. 2004, 45(25), 8377-8393). Bulk films (e.g., films with thicknesses on the order of 25 μm or greater) were mounted directly between the aluminum tape discs.

However, the thin films used here are extremely fragile, and special care was taken in preparing them for permeation testing. The HBA-HNA-MCLCP/PDMS bilayer thin film was floated from the Si substrate in water and then lifted onto a copper wire frame (FIG. 16). The free-standing film samples were then annealed at 140° C. for 1 hour prior to the permeation test. A porous ceramic disc (e.g., Anopore Disc) was used as the mechanical support for the film to prevent tearing upon exposing the upstream side to pressurized gas. FIG. 17 shows a cross-sectional view of a mounted sample.

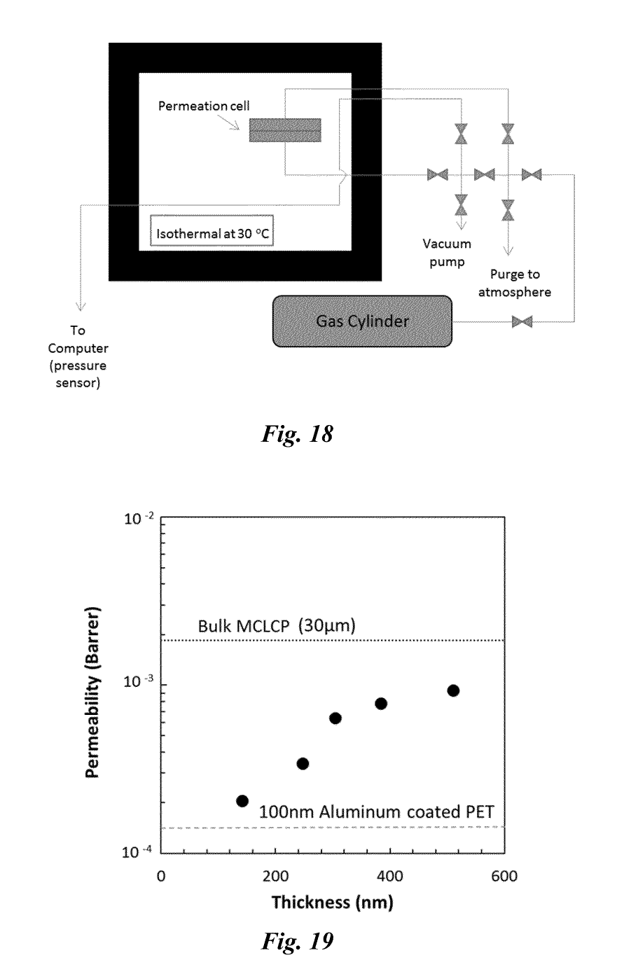

The gas permeation coefficient was determined using a standard constant volume, variable pressure method (Koros W J et al. J Polymer Sci Part B: Polymer Phys. 1976, 14(4), 687-702). A drawing of the apparatus is shown in FIG. 18. In this type of system, a film masked with aluminum tape is placed into the permeation cell sample holder, which divides the system into upstream and downstream sides. Prior to permeation testing, the system is evacuated using a vacuum pump. Upon exposing the upstream side of the film to gas at a known pressure, gas begins to permeate through the film and pass into the downstream side of the system. A pressure transducer allows the gas pressure in the downstream side of the system to be measured over time.

Measurements were carried out at 30° C., with an upstream pressure of 2 atm. A liquid nitrogen trap was placed between the permeation cell and the vacuum pump to minimize any contamination from vacuum pump oil vapors and decrease the permeation cell leak rate. The permeability (P) of the polymer membrane was calculated by the following equation:

$$P = \frac{{V}_{d} \cdot l}{{p}_{2} \cdot A \cdot R \cdot T} [ {( \frac{d p}{d t} )}_{m} - {( \frac{d p}{d t} )}_{leak} ] \qquad ( 4 )$$

where P, l and A are the gas permeability, thickness and exposed area of the film sample, respectively; V_{d} is the downstream volume, p2 is upstream pressure, R is the gas constant, (dp/dt)ₘ is the measured rate of pressure increase in the downstream side while (dp/dt)ₗₑₐₖ is the rate of downstream pressure increase due to the apparatus leaks allowing ambient air into the system.

The effect of nanoconfinement on the gas permeability of LCPs was investigated; low gas permeability can make LCPs candidates for ultra-high barrier packaging materials. FIG. 19 shows the O₂ permeability of HBA-HNA-MCLCP thin films. The ‘bulk’ value was obtained by measuring the permeability of a solution cast HBA-HNA-MCLCP film with a thickness of about 30 μm. The O₂ permeability of the solution cast HBA-HNA-MCLCP film was measured to be 1.8×10⁻³ barrer, which is higher than the reported value of 7×10⁻⁴ barrer for the extruded film (U.S. Pat. No. 6,294,640; McKeen L W. Film Properties of Plastics and Elastomers. William Andrew: Waltham, M A, 2012). Many properties (e.g., rheology, permeability, etc.) of LCPs can depend on the previous processing history of the LCP (Weinkauf D H and Paul D R. J Polymer Sci Part B: Polymer Phys. 1992, 30(8), 817-835; Cantrell G R et al. J Polymer Sci Part B: Polymer Phys. 1999, 37(6), 505-522).

FIG. 19 shows the O₂ permeability decreased steadily with decreasing film thickness for the HBA-HNA-MCLCP thin films. The lowest O₂ permeability was observed for a 150 nm thick thin film with an O₂ permeability value of 2.05×10⁻⁴ barrer, which is almost an order of magnitude lower than that of the bulk film. There are no conventional plastic packaging films that have a comparable gas barrier property. For example, the O₂ permeability of polypropylene, PET, poly(vinyl alcohol), and poly(vinylidene chloride) are 1.5, 0.11, 0.35 and 0.0376 barrer, respectively (Weinkauf D H and Paul D R. J Polymer Sci Part B: Polymer Phys. 1992, 30(8), 817-835; Aiba S et al Ind & Eng Chem Fundamentals. 1968, 7(3), 497-502). Such a low permeability is comparable to that of a PET film coated with a 100 nm thick aluminum layer by plasma deposition (i.e. metalized film) (Chatham H. Surface & Coatings Tech. 1996, 78(1-3), 1-9).

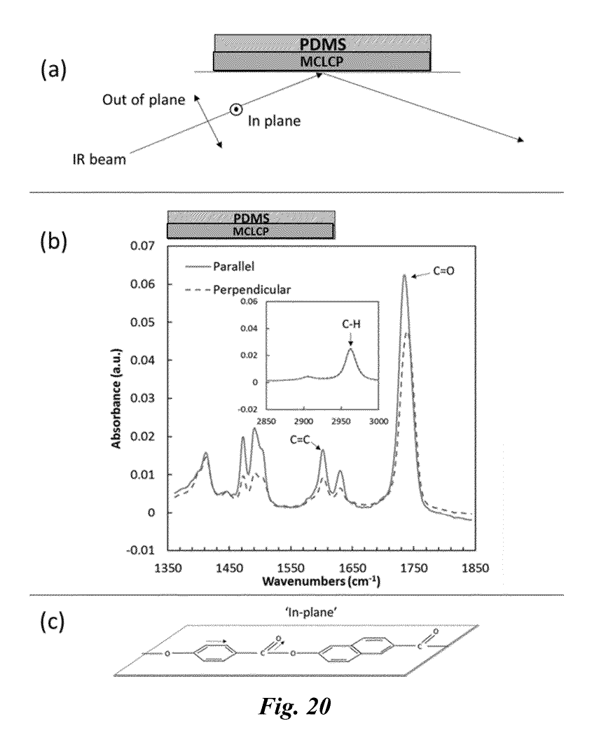

Polarized ATR-FTIR was performed to investigate the orientational order of HBA-HNA-MCLCP thin films. As shown in FIG. 20a, in the polarized ATR-FTIR measurement, the incident IR beam is polarized in the direction parallel and perpendicular to the thin film surface, and hence the dichroic ratio (A_{∥}/A_{⊥}) can be used to characterize the orientational order of polymer chains (Wang X et al. Macromolecules. 2011, 44(24), 9731-9737; Lee DH et al. Macromolecules. 2007, 40(17), 6277-6282).

FIG. 20b shows the polarized ATR-FTIR results of a 200 nm free-standing HBA-HNA-MCLCP thin film with a PDMS top layer. The spectrum was normalized by the 2960 cm⁻¹ band, which was assigned to the C—H vibration in the PDMS and was insensitive to the orientation (Efimenko K et al. J Colloid and Interface Sci. 2002, 254(2), 306-315). The absorption band around 1602 cm⁻¹ was used to characterize the chain orientation of the HBA-HNA-MCLCP thin film, which was assigned to the (—C═C—) stretching vibration of the naphthalene rings in the polymer backbone (Branciforti MC et al. J Appl Polymer Sci. 2006, 102(3), 2241-2248). The absorbance at 1602 cm⁻¹ is stronger with parallel polarization, indicating that the polymer main chains are aligned parallel to the film plane. Meanwhile, the carbonyl group stretching vibration (1750 cm⁻¹) peak also exhibits stronger absorption in direction parallel to the surface, implying that the polymer chains were lying flat with an in-plane structure.

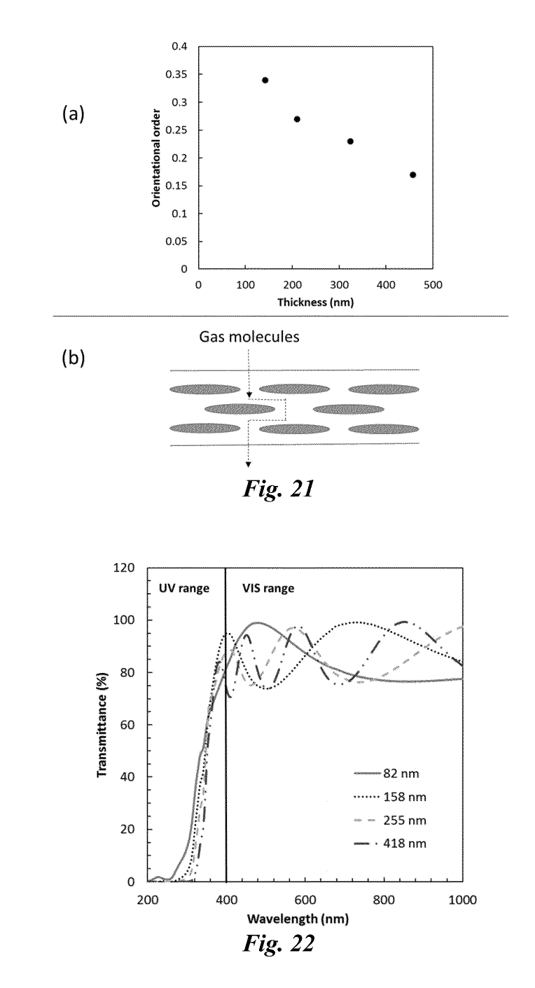

The in-plane orientational order of HBA-HNA-MCLCP thin films was calculated from the dichroic ratio of the —C═C— stretching vibration peak at 1602 cm⁻¹ (FIG. 21a). The in-plane orientational order of the HBA-HNA-MCLCP polymer chains increased with decreasing film thickness, this thickness dependent anisotropic orientation can be due to the effect of confinement on the rigid rod-like LCP chains. In the HBA-HNA-MCLCP thin films, the available conformations for the stiff chains are restricted in nanoconfined geometries. Additionally, reduction of the dimension in the direction normal to the film surface can force the rod-like polymer chains to lie flat in the film plane. Such results were consistent with those of HBA-HNA-MCLCP thin films supported on hard substrates.

In ordered liquid crystal domains, the LCP chain plane is considered impermeable to gas molecules; gas molecules can penetrate through the edges of the intermolecular regions. The decrease in permeability for the LCP thin films can be attributed to the increased tortuosity of the diffusion pathway of gas molecules when the LCP chains are well aligned in the plane direction (FIG. 21b). This result is consistent with that reported by Li et al (Li J et al. Langmuir. 2001, 18(1), 112-119), who found that a small molecule liquid crystal became almost impermeable to gas when the molecules adopted an in-plane smectic structure. Additionally, studies on permeability of extruded LCP films have also found that the more oriented ‘skin layer’ possessed much lower permeability than that of the inner part (‘core’) of the film (Weinkauf D H and Paul D R. J Polymer Sci Part B: Polymer Phys. 1992, 30(8), 817-835).

The low gas permeability of thin films can also be due to a reduced liquid crystal domain boundaries due to an increased domain size. Studies have shown that the liquid crystal domain size and morphology can be modified in spin coated thin films (Chabinyc M L et al. JACS. 2007, 129(11), 3226-3237; Zhao N et al. Macromolecules. 2004, 37(22), 8307-8312). Much larger domains could be formed due to the enhanced chain ordering, resulting in fewer domain boundaries. As small gas molecules can only transport through the grain boundaries of anisotropic regions with different orientation (Weinkauf D H and Paul D R. J Polymer Sci Part B: Polymer Phys. 1991, 29(3), 329-340), the reduction in domain boundaries can result in lower gas permeability.

Overall, the gas barrier properties of the nanoconfined HBA-HNA-MCLCP were enhanced due to the increased in-plane chain ordering. For the design and execution of packaging strategies, the LCP nanolayers can be incorporated into conventional polymeric films with sufficient barrier properties at lower cost (e.g., incorporation of a LCP layer into multilayer films).

Besides barrier properties, optical transparency can be useful for the design and application of barrier films in a wide range of end uses, including packaging materials for food/medicine (Arora A and Padua G W. J Food Sci. 2010, 75(1), R43-R49) and flexible organic electronic devices (Choi M C et al. Progress in Polymer Sci. 2008, 33(6), 581-630; Möller M W et al. Adv Mater. 2012, 24(16), 2142-2147). For instance, packaging films with high visible light transparency are highly desired for organic light emitting devices (OLED) in order to increase their efficiency (Choi M C et al. Progress in Polymer Sci. 2008, 33(6), 581-630).

FIG. 22 shows the transmittance spectra of free-standing single layer HBA-HNA-MCLCP thin films. All spectra exhibit interference fringes, indicating the presence of smooth film surfaces. This makes it difficult to compare the transmittance of a specific wavelength between films. Therefore, the average transmittance for the visible region (400 nm-750 nm) of all samples were calculated (Table 1) (Kuo C C et al. J Nanomater. 2010, 2010, 840316). All the films exhibit very good transparency (transmittance >80%) in the visible light region (Table 1). Furthermore, a steady decrease in visible light transmittance was observed with increasing film thickness, which can be due to the increased light pathway for the thicker films.

TABLE 1
Thickness and average transmittance
of HBA-HNA-MCLCP thin films.

| Thickness | Average Transmittance (%) |
|---|---|
| 82 nm | 88.63 |
| 158 nm | 87.08 |
| 255 nm | 84.77 |
| 418 nm | 83.07 |

Understanding the structure and properties of nanoconfined LCPs can be used to control and improve their performance in a variety of technologies, including high performance gas barrier/separation membranes. HBA-HNA-MCLCP thin films were fabricated by spin coating and a series of well-developed techniques (e.g., multiple cycle spin coating, PDMS top coat, etc.) were employed to allow measurement of the permeability of free-standing thin films. The gas barrier properties of HBA-HNA-MCLCP were enhanced by nanoconfinement, i.e., the O₂ permeability of HBA-HNA-MCLCP thin films steadily decreased with decreasing film thickness. The permeability can be nearly an order of magnitude lower when compared to that of the bulk. Such reduction in gas permeability can be imparted by the in-plane orientational order imposed by nanoconfinement. It was found that the HBA-HNA-MCLCP chain exhibited an in-plane orientational order with its chain axis aligned parallel to the film plane direction. As a consequence, the gas permeability was reduced due to the increased tortuosity of the diffusion pathway of gas molecules. Further studies on the optical properties of HBA-HNA-MCLCP thin films revealed that these thin films exhibited transparency in the visible light region. The nanoconfined HBA-HNA-MCLCP films can be used as part of a new approach for ultra-high barrier, transparent and mechanically flexible packaging materials.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. A composition, comprising: one or more layers of a liquid crystal polymer, wherein each of the one or more layers has an average thickness of 1000 nanometers or less.

2. The composition of claim 1, wherein the one or more layers has an oxygen permeability of 1×10⁻³ barrer or less.

3. The composition of claim 1, wherein the average thickness of each of the one or more layers is from 5 nm to 1000 nm.

4. The composition of claim 1, wherein the liquid crystal polymer comprises a main chain liquid crystal polymer.

5. The composition of claim 1, wherein the liquid crystal polymer comprises a side chain liquid crystal polymer.

6. The composition of claim 1, wherein the liquid crystal polymer comprises a random copolyester comprising hydroxybenzoic acid and 2,6-hydroxynaphthoic acid.

7. The composition of claim 1, wherein the liquid crystal polymer contains mesogens which are aligned within a plane of each of the one or more layers.

8. The composition of claim 1, wherein the liquid crystal polymer is optically anisotropic.

9. The composition of claim 1, wherein the one or more layers has an ordinary refractive index (nₒ), and an extraordinary refractive index, wherein the ordinary refractive index (nₒ) is greater than the extraordinary refractive index (nₑ) at one or more wavelengths.

10. The composition of claim 9, wherein the ordinary refractive index (nₒ) is greater than the extraordinary refractive index (nₑ) by 10% or more at one or more wavelengths.

11. The composition of claim 9, wherein the ordinary refractive index (nₒ) is from 1.7 to 1.9 at one or more wavelengths from 400 nm to 1000 nm.

12. The composition of claim 9, wherein the extraordinary refractive index (ne) is from 1.5 to 1.7 at one or more wavelength from 400 nm to 1000 nm.

13. The composition of claim 1, wherein the one or more layers has an average transmittance of 80% or more over wavelengths from 400 nm to 750 nm.

14. The composition of claim 1, wherein one or more of the layers has an orientational order of 0.15 or more.

15. The composition of claim 1, wherein the one or more layers has an oxygen permeability of 2.1×10⁻⁴ barrer or less.

16. The composition of claim 1, wherein the one or more layers is substantially impermeable to gas diffusion.

17. The composition of claim 1, further comprising one or more layers of non-liquid crystal polymers.

18. The composition of claim 1, wherein the one or more layers has a T_{g} that increases as the thickness of the layer decreases.

19. The composition of claim 1, wherein the one or more layers has a T_{g} that is greater than a T_{g} for the liquid crystal polymer in bulk.

20. The composition of claim 1, wherein the one or more layers has a T_{g} that decreases as the thickness of the one or more layers decreases.

21. The composition of claim 1, wherein the one or more layers has a T_{g} that is less than a T_{g} for the liquid crystal polymer in bulk.

22. The composition of claim 1, further comprising a substrate, wherein the one or more layers is supported by the substrate.

23. A gas barrier comprising the composition of claim 1.

24. A food packaging material comprising the composition claim 1.
